(19) United States
(12) Patent Application Publication
(10) Pub. No.: US 2025/0296293 A1
(43) Pub. Date: Sep. 25, 2025

(54) PACKAGING MATERIAL COMPRISING A CELLULOSE FOAM

(71) Applicant: Stora Enso OYJ, Helsinki (FI)

(72) Inventors: Daniel Hult Torron, Täby (SE); Oruc Köklükaya, Lidingö (SE)

(73) Assignee: Stora Enso OYJ, Helsinki (FI)

(21) Appl. No.: 19/112,333

(22) PCT Filed: Sep. 22, 2023
(86) PCT No.: PCT/IB2023/059381

§ 371 Date: Mar. 17, 2025

(30) Foreign Application Priority Data
Sep. 23, 2022 (SE) 2230309-3

(51) Int. Cl. B32B 5/32; B32B 3/10; B32B 5/24; B32B 7/12; B32B 29/00; B32B 38/00

(52) U.S. Cl. CPC B32B 5/32; B32B 3/10; B32B 5/245; B32B 7/12; B32B 29/007; B32B 38/164; B32B 2250/02; B32B 2250/22; B32B 2262/04; B32B 2266/02; B32B 2307/72; B32B 2553/00

(57) ABSTRACT

The present invention relates to a packaging material comprising a cellulose foam having a density in the range of from 10 to 80 kg/m³ and a substrate attached to at least one outer surface of the cellulose foam.

### FIELD OF THE INVENTION

The present invention relates to a packaging material comprising a cellulose foam and to a method for producing a packaging material comprising a cellulose foam.

### BACKGROUND

Different porous materials, such as foams, are commonly used in applications such as insulation in buildings and vehicles and as packaging materials that are used to protect various goods during storage and transportation.

Depending on the item to be protected, different types of protective packaging materials can be used. For many items, a low-weight cushioning material that reduces impact shock and vibrations is used. Common examples of such cushioning materials are petroleum-based polymer foams such as polyurethane, polyethylene and expanded polystyrene. The foams used should be low-weight, stable and easy to manufacture.

Today, there is an increasing interest in replacing petroleum-based polymers with polymers from renewable resources, i.e. biobased polymers. Cellulose is the most abundant renewable natural polymer on earth and is therefore of special interest. For a cellulose foam, recycling of the material in regular recycling streams may be possible, depending on the composition of the foam.

There are several examples of cellulose foams, prepared using different methods. Drying the wet foam composition is often a critical step. Since the stability of the wet foam is typically low, moulds are commonly used to prevent the foam from collapsing during drying. WO20200011587 A1 describes a porous material that is prepared by aerating a paste comprising cellulose fibres and gluten and depositing the aerated paste in a mould where it is dried. The dried porous material has the shape of the mould. WO2015036659 A1 describes a moulded fibrous product prepared by foaming an aqueous suspension of natural fibres in combination with synthetic fibres and surfactant, feeding the fibrous foam to a mould and drying the foam by first mechanically withdrawing a part of the water followed by evaporating water to produce a dry fibrous product.

To enable a more versatile and efficient processing, foams that are dimensionally stable already in the wet state are desired.

When replacing foams from petroleum-based polymers with e.g. cellulose foams, there are a number of challenges related to manufacturing processes that must be overcome.

For commercially available foams made from petroleum-based polymers, automated foam production and packaging lines use two main means of lifting and moving products, namely pins and vacuum suction. The former entails a movable arm having several metal pins that can be inserted into the foam at an angle, allowing the machine to lift the foam. The pin process leaves small holes in the product, where size depends on the gauge thickness of the pin. The pins need to be sufficiently thick as to not risk breaking, leaving behind metal residue inside the product. Another common method for lifting is vacuum suction, whereby suction cups are pressed against the surface of the foam and air is evacuated. This process relies heavily on having a low air permeable surface in order to generate a vacuum suction and sufficient lift. Furthermore, certain converting equipment such as plotting tables rely on vacuum from below to hold samples in place while cutting. In these applications it is highly important that the samples do not move since this will break the oscillating blade, as well as resulting in a poor quality of the design thus leading to waste of material.

Since cellulose foams generally have a high air permeability due to the porous structure of the foam, it is not possible to use vacuum lifting or fixating equipment during production and converting operations.

One of the most common converting techniques for packaging materials comprising foams made from petroleum-based polymers is die-cutting, where blades arranged in a pattern is pressed against the foam to cut out a specific shape. The blades can either be fitted onto plates for conventional pressing machines or onto rolls for continuous production lines. When it comes to cellulose foams, the load bearing and resilience properties of the foam are typically not sufficient for die-cutting to be an option. Also in other applications, such as in packaging of heavy objects, the rigidity and strength of a cellulose foam may be too low for the foam to be a viable option.

Another drawback with packaging materials comprising cellulose foams is that the surface characteristics of the foam in terms of smoothness does not compare to conventional paper making, where the material is pressed to generate a very smooth surface. The surface texture of the cellulose foam is obtained by the self-consolidation of fibres upon drying. Furthermore, the low-density and porous nature of the cellulose foam presents plenty of capillary action for water to diffuse into, leading to ink bleeding when printing and a lower fidelity print as a result. Lastly, the high moisture uptake of the cellulose foam due to its fibrous and porous nature can present difficulties to deal with condensation of water when used in thermal packaging of frozen goods.

Thus, there is still need for a packaging material comprising a biobased foam, where the packaging material is recyclable and that also enables use of automated processes including vacuum lifting and fixating equipment. To facilitate efficient manufacturing of the foam, particularly in terms of drying, it is desired that the foam is dimensionally stable also in the wet state.

In addition, it is also desired that the surface characteristics, such as surface gloss, smoothness, ink absorbency, hydrophobicity and resistance to scratching, of the packaging material comprising a biobased foam can be tailored.

Further, it is desired that the strength and rigidity of the packaging material comprising a biobased foam is improved, without impairing the cushioning effect.

### SUMMARY OF THE INVENTION

It is an object of the present invention to provide an improved packaging material comprising a cellulose foam, which packaging material is recyclable and made from renewable sources, and which eliminates or alleviates at least some of the disadvantages of the prior art materials.

It is a further object of the present invention to provide a packaging material comprising a cellulose foam that can be used in processes involving vacuum lifting and fixating equipment.

It is a further object of the present invention to provide a packaging material comprising a cellulose foam which enables tailormade surface characteristics, as well as sufficient strength and rigidity properties, depending on the use of the packaging material.

It is a further object of the present invention to provide a cellulose foam material that can be produced by drying a wet foam without use of a mould to enable versatile production methods.

The above-mentioned objects, as well as other objects as will be realized by the skilled person in light of the present disclosure, are achieved by the various aspects of the present disclosure.

According to a first aspect, the present invention relates to a packaging material comprising a cellulose foam having a density in the range of from 10 to 80 kg/m³, and a substrate, wherein the substrate is attached to at least one outer surface of the cellulose foam.

It has surprisingly been found that attaching a substrate to at least one side of a cellulose foam, the air permeability of the cellulose foam is decreased so that processes using vacuum lifting and fixating equipment can be used. This facilitates processing of the foam, particularly in terms of operations used when converting the foam for use in different packaging applications. The type of substrate can further be selected so as to provide the cellulose foam with other desired properties such as surface smoothness, ink absorbency, hydrophobicity, surface gloss, improved scratch resistance and increased strength and rigidity. The properties of the cellulose foam can thus be tailored depending on the end use of the foam by attaching the foam to a substrate. The substrate may preferably be a paper or board substrate.

The cellulose foam preferably comprises in the range of from 71 to 95 wt % cellulose fibres, as calculated on the total weight of solid content in the foam, in the range of from 4 to 24 wt % of a water-soluble thickener, as calculated on the total weight of solid content in the foam, and at least two surfactants. A wet foam having such a composition will be free-standing and does not require a mould or any other forming means to retain its shape during drying.

According to a second aspect, the present invention relates to a method for producing a packaging material comprising a cellulose foam having a density in the range of from 10 to 80 kg/m³, the method comprising the following steps:
a) providing a cellulose foam;
b) providing a substrate having a first surface;
c) attaching the first surface of the substrate to at least one outer surface of the cellulose foam so as to obtain a packaging material;
d) optionally drying the packaging material.

The packaging material according to the first aspect may be produced by the method according to the second aspect.

### DETAILED DESCRIPTION

The term “foam”, as used herein, refers to a substance made by trapping air or gas bubbles inside a solid or liquid. Typically, the volume of gas is much larger than that of the liquid or solid, with thin films separating gas pockets. Three requirements must be met in order for foam to form. Mechanical work is needed to increase the surface area. This can occur by agitation, dispersing a large volume of gas into a liquid, or injecting a gas into a liquid. The second requirement is that a foam forming agent, typically an amphiphilic substance, a surfactant or surface active component, must be present to decrease surface tension. Finally, the foam must form more quickly than it breaks down.

The term “cellulose foam”, as used herein, refers to a foam comprising cellulose, and other components such as thickeners, surfactants and additives. The main component of the cellulose foam is cellulose, such that cellulose constitutes at least 70 wt % of the dry content of the cellulose foam. Cellulose is in the form of fibres, and the foam can thus also be defined to be a fibrous foam or a cellulose fibre foam. The cellulose foam may be wet or solid.

The term “wet foam”, or “wet cellulose foam”, as used herein, refers to a wet foam comprising cellulose, and other components such as thickeners, surfactants and additives. Gas bubbles are present within the wet foam. The wet foam is freestanding and behaves as a viscoelastic solid. This means that the wet foam has both viscous and elastic properties. The wet foam will behave as a solid, and thus be freestanding, unless a large enough force is applied so that it starts to flow and instead behave as a viscous material. Depending on the magnitude and timescale of any applied shear stress, the wet foam can show a predominantly viscous or elastic behaviour.

The term “solid cellulose foam”, or “dry cellulose foam”, as used herein, refers to a dry porous cellulose material that has been formed from a wet cellulose foam, i.e. a foam formed material. During the drying process, a closed wet cellulose foam is transformed into an open solid cellulose foam. The network of cellulose fibres is prevented from collapsing during drying. The solid cellulose foam will as a result have a shape that to a large extent corresponds to that of the wet cellulose foam. The dry content of the solid cellulose foam is at least 95 wt % as calculated based on the total weight of the solid cellulose foam. The shape and density of the solid cellulose foam is retained also in a non-confined state. The solid cellulose foam has an open cell structure, allowing air to occupy the pores within the foam. The solid cellulose foam can also be described as a porous material or a low-density material.

The first aspect of the present invention relates to a packaging material comprising a cellulose foam. The cellulose foam is dry and may have a solid content in the range of from 95 to 100 wt %, preferably from 98 to 100 wt %, as calculated on the total weight of the cellulose foam. The cellulose foam is solid and has a density in the range of from 10 to 80 kg/m³, preferably from 10 to 60 kg/m³, or from 20 to 50 kg/m³.

The cellulose foam preferably comprises cellulose fibres, in a range from 71 to 95 wt %, such as from 75 to 95 wt %, based on the total dry weight of the cellulose foam.

Cellulose fibres suitable for use in the present invention can originate from wood, such as softwood or hardwood, from leaves or from fibre crops (including cotton, flax and hemp). The cellulose fibres suitable for use in the present invention can also originate from regenerated cellulose such as rayon and Lyocell. The cellulose fibres suitable for use in the present invention may include lignin or hemicellulose or both, or the cellulose fibres may be free from lignin and hemicellulose. Preferably, the cellulose fibres originate from wood, more preferably the cellulose fibres are pulp fibres obtained by pulping processes which liberates the fibres from the wood matrix. Pulp fibres can be liberated by mechanical pulping, obtaining mechanical pulp such as thermomechanical pulp (TMP) or chemical thermomechanical pulp (CTMP), or by chemical pulping such as Kraft pulp or pulps obtained by the sulphite process, soda process or organosolv pulping process. More preferably, the cellulose fibres are pulp fibres liberated by chemical pulping processes. The different characteristic of each cellulose fibre will affect the properties of the final cellulose foam. A cellulose fibre is significantly longer than it is wide. Cellulose fibres can have a mean width of 0.01 to 0.05 mm. The fibre length of softwood can be from 2.5 to 4.5 mm, while hardwood can have a fibre length from 0.7 to 1.6 mm, and Eucalyptus from 0.7 to 1.5 mm. However, the fibre length can vary considerably with different growing place etc. The cellulose fibres in the cellulose foam disclosed herein can have a length from 0.1 mm to 65 mm, or from 0.1 mm to 10 mm, or from 0.5 mm to 65 mm, or from 0.5 mm to 10 mm, or from 0.5 mm to 7 mm. The fibre lengths may provide different mechanical characteristics to the foam. Due to the length of fibres, they can entangle with each other and impart fibre to fibre interbonds that bring strength to the foam. The aspect ratio, i.e. the ratio of the fibre length to the fibre width, of the cellulose fibres in the cellulose foam according to the present invention can be at least 10, at least 25, at least 50, at least 75, or at least 100, which provides for preservation and stabilization of the foam structure during the drying procedure, making it possible to dry the wet cellulose foam with retained shape. The aspect ratio can be up to 6500, or preferably up to 2000.

The cellulose fibres may be modified to provide different properties to the final cellulose foam. For example, phosphorylated fibres or periodate oxidized fibres could also be used when producing a cellulose foam according to the present invention.

Preferably, the cellulose fibres are selected from wood pulp, such as softwood Kraft bleached pulp, hardwood pulp, chemical-thermomechanical pulp, and from dissolving pulp, or a combination of one or more of these. More preferably the cellulose pulp fibres are from softwood pulp, chemical-thermomechanical pulp, or dissolving pulp. Most preferably the cellulose pulp fibres are from softwood pulp, such as softwood Kraft bleached pulp.

The cellulose foam preferably comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants.

The water-soluble thickener may have a molecular weight of from 80 000-250 000 g/mol, or from 83 000-197 000 g/mol. Exemplary water-soluble thickeners are selected from carboxy methyl cellulose (CMC), methyl cellulose (MC), hydroxyethyl cellulose (HEC), ethyl hydroxyethyl cellulose (EHEC), methyl hydroxypropyl cellulose (MHPC), starch, xanthan, guar gum, and xyloglucan, or mixtures thereof. The fact that the thickener is water-soluble facilitates recycling of the cellulose foam.

The water-soluble thickener may improve the fibre-fibre bonding strength, primarily through hydrogen bonding, in the cellulose foam, Therefore, the amount of water-soluble thickener will influence the mechanical performance of the cellulose foam, and especially the bulk of the material. A higher content of water-soluble thickener provides for a stiffer material. Thus, the water-soluble thickener enables tailoring of the mechanical properties.

The cellulose foam may also comprise a mixture of at least two surfactants. One of the at least two surfactants is preferably a fast-acting surfactant, a suitable surfactant for this purpose is an anionic surfactant, preferably a low-molecular weight anionic surfactant. The anionic surfactant may have an apparent pka of from 3.2 to 3.8, preferably from 3.4 to 3.6, or an apparent pKa of 3.5 in a solution having a pH of from 7 to 9, preferably a pH of 8. The low-molecular weight anionic surfactant may be selected from sodium dodecyl sulphate (SDS); potassium dodecyl sulphate, sodium laureth sulphate (SLES); sodium dodecylbenzenesulphonate; sodium cocoyl sarcosinate; sodium lauroyl sarcosinate. The low-molecular weight anionic surfactant is preferably selected from sodium dodecyl sulphate (SDS); sodium p-n-dodecylbenzenesulphonate; sodium cocoyl sarcosinate; and sodium lauroyl sarcosinate. More preferably the low-molecular weight anionic surfactant is sodium cocoyl sarcosinate. The anionic surfactant may be biodegradable.

The other one of the at least two surfactants is preferably a co-surfactant. The co-surfactant may be selected from the group comprising surfactants having an apparent pKa of at least 8, or at least 9, in a surfactant solution having pH of from 7 to 9, preferably having a pH of 8; and amphoteric betaines. The co-surfactant may have maximum apparent pKa of 10. The co-surfactant preferably has a long carbon chain, more preferably a carbon chain with 14 carbon atoms (C14). The co-surfactant may be selected from high pKa fatty acids, such as from plant derived feedstock, e.g. tetradecanoic acid (myristic acid), sodium oleate, lauric acid, palmitic acid, and stearic acid; glucose based co-surfactants with an aliphatic carbon tail, such as alkyl glycosides, alkylpolyglucosides, alkyl thio-glycosides, and alkyl maltosides; amphoteric betaines, such as cocamidopropyl betaine (CAPB), and sodium cocoiminodipropionate (CADP); polyethylene glycol sorbitan monolaurate, i.e. tween® (e.g. tween® 20, tween® 80 and tween® 85); and polyoxyethylene lauryl ethers, such as polyethylene glycol dodecyl ether, pentaethylene glycol monododecyl ether and octaethylene glycol monododecyl ether.

Thus, the at least two surfactants used in the cellulose foam preferably comprise a mixture of an anionic surfactant and a co-surfactant. The molar ratio between anionic surfactant to co-surfactant may be from 0.2:1-3:1, preferably from 0.5:1 to 2:1. The total amount of the at least two surfactants together in the cellulose foam may be 0.6-5 wt %, or 0.8-2.0 wt %, as calculated on the total weight of the cellulose foam.

The cellulose foam can be re-dispersed in water and as a result be recyclable in regular paper recycling streams.

The cellulose foam may be prepared using a method comprising the following steps:
disintegrating cellulose fibres in water to obtain a slurry of cellulose fibres;
adding a water-soluble thickener to the slurry to obtain a mixture of thickener and cellulose fibres in water;
adding at least two surfactants to the mixture to obtain a fibre suspension; and
aerating the fibre suspension to obtain a wet foam, wherein the wet foam comprises 10-38 wt % cellulose fibres, 0.5-10 wt % of the water-soluble thickener, and 0.1-2 wt % surfactants, as calculated on the total weight of the wet foam, and wherein the foam has a density of from 140-500 kg/m³ and a yield stress of from 40 to 400 Pa.
drying the wet foam to obtain a dried cellulose foam.

Addition of a water-soluble thickener increase the viscosity of the slurry and enables incorporation of enough air to generate a densely packed foam during aeration. Since the cellulose fibres are mixed in high concentrations a drainage step is not needed, which enables the use of a water-soluble bio-based thickener in high concentrations.

Addition of a fast-acting surfactant will contribute to the formation of a cellulose foam with a high density and a high viscosity as it will quickly settle at the air-water interphase during aeration. This enables a free-standing wet cellulose foam. Addition of a co-surfactant along with the fast-acting surfactant will further improve the properties of the cellulose foam since it will facilitate the action of the fast-acting surfactant. A co-surfactant having a suitable pKa and a long carbon chain further contributes to a stable fibre suspension and a stable wet cellulose foam.

Upon aeration the composition comprising cellulose fibres, thickener and at least two surfactants will form a highly stable wet fibre foam. The aeration may be performed by mechanical agitation, and a substantial amount of air is incorporated into the material. The formation of a foam will be promoted by the surfactants. By adjusting the stability of the wet foam with the use of thickeners and surfactant combinations, a free-standing cellulose foam can be made without the use of a cross-linker or fibrillated cellulose. A good stability of the foam prevents ripening, i.e. change in bubble size, and drainage. The obtained wet foam is free-standing and does not require a mould or a forming fabric to retain its shape upon drying. The wet foam can thus be formed into a free-standing foam that is stable enough to be dried in the absence of a supporting mould without collapsing. As a result, objects can be formed and dried without the use of a mould.

The bubble size in the wet foam is typically below 100 um. This provides for a homogenous wet foam with good stability that does not flocculate during processing. During processing, and also during the subsequent drying step, the average bubble size is maintained to a large extent and the cellulose fibres remain well dispersed. The resulting solid cellulose foam obtained by drying the wet foam will be homogenous in structure, strong, have good mechanical properties, a smooth surface and no defects. A smooth surface is beneficial when a substrate is to be attached to the foam, since it may facilitate adhesion.

In comparison, a wet cellulose foam with low stability has a larger average bubble size (i.e. typically above 100 μm) and the bubbles will coalesce faster during processing and drying such that larger bubbles are formed. In addition, the cellulose fibres will form clusters during processing and drying. This results in the wet foam collapsing during drying. The resulting solid cellulose foam will not have a homogenous structure and will also contain defects in the form of cavities resulting from the coalesced bubbles in the wet foam. Such a solid cellulose foam is, due to the defects, weak and has a rough surface.

Because of the high solid content, the wet foam does not need to be dewatered before it is dried. The foam may be dried by evaporation at room temperature or at an elevated temperature, such as a temperature of from 40° C. to140° C. The dry cellulose foam may have a density of from 10 to 80 kg/m³, or from 10 to 60 kg/m³ or from 20 to 50 kg/m³.

In preferred embodiments the cellulose foam comprises cellulose fibres in a range of from 71 to 95 wt %, such as from 75 to 95 wt %, based on the total dry weight of the cellulose foam, a water-soluble thickener in a range of from 4 to 24 wt %, such as from 5 to 20 wt %, based on the total dry weight of the cellulose foam, and at least two surfactants. A wet cellulose foam having such a composition is homogenous in structure and has a good stability as discussed above. Such a wet cellulose foam can also be dried without prior dewatering.

The cellulose foam may be prepared by a two-step deposition. In a first deposition, a wet foam is deposited as discrete units on a surface and at least partially dried. During drying, a densified layer is formed on the outer surface of the discrete units. In a second deposition a wet foam, preferably having the same composition as the wet foam in the first deposition, is deposited so that it fills the spaces surrounding the discrete units of the first deposition. After drying, a solid cellulose foam comprising discrete units of foam embedded in a foam matrix is obtained. The densified layer on the outer surface of the discrete units provides mechanical support during drying of the foam in the second deposition and the entire cellulose foam by helping to keep the shape of the discrete units.

The cellulose foam in the packaging material according to the first aspect may have any shape, such as a block, a cube, a cylinder or any irregular shape. Preferably, the cellulose foam has at least one flat surface. A flat surface facilitates attachment of the substrate. The substrate is attached to at least one outer surface of the cellulose foam. The term “outer surface” as used herein refers to the outermost surface of the cellulose foam. It is not intended to mean the outermost surface of the packaging material. The term “flat” as used herein refers to a level surface with no indentations or protruding portions.

In some embodiments, the cellulose foam may have at least one non-flat surface, such as a surface having protruding portions, onto which the substrate is attached.

In one embodiment, the cellulose foam is provided in the form of a plank having a thickness in the range of from 1 to 20 cm, preferably from 1 to 10 cm, more preferably from 4 to 6 cm. The length and width dimensions of the plank are typically in the range of from 100 to 300 cm. The planks may be cut into smaller pieces but preferably having the same thickness also after cutting. In embodiments where the cellulose foam is provided in the form of a plank, outer surfaces are thus present on the top surface, the bottom surface and the side surfaces of the plank.

The cellulose foam may on at least one outer surface have a densified layer. In embodiments where the cellulose foam is provided in the form of a plank, the cellulose foam has densified layers on at least the top surface and bottom surface, and optionally on the side surfaces.

The densified layer comprises cellulose fibres that are packed more tightly and partly oriented differently compared to the bulk. The densified layer is formed on the outer surface of the wet foam during drying of the wet foam and remain on the outer surface of the dried cellulose foam. The densified layers have improved mechanical stability and strength as compared to the core of the cellulose foam. The core of the cellulose foam comprises a homogenous open-cell fibre network. The core is highly porous, and even though the densified layer has a denser structure than the core, it is still porous.

The densified layer thus provides the cellulose foam with increased stability and mechanical strength. In embodiments where the cellulose foam is provided in the form of a plank, it may therefore be advantageous that during cutting of the foam planks, cutting is carried out such that the thickness of the planks remains the same also after cutting, thus ensuring that the densified layers are still present on the top surface and bottom surface. However, in other applications the plank may be cut so that no densified layers are present after cutting.

The substrate may be attached to an outer surface of the cellulose foam comprising a densified layer, or it may be attached to an outer surface of the cellulose foam that does not comprise a densified layer.

According to the first aspect of the present invention, a substrate is attached to at least one outer surface of the cellulose foam.

Any suitable substrate may be used, such as a plastic film, a metal foil or a fibrous substrate. Preferably, the substrate is selected from paper or board. The air permeability of the substrate may be lower than that of the cellulose foam. The substrate may thus be selected such that it has a sufficiently low air permeability depending on the application.

By attaching a substrate to the cellulose foam, the air permeability of the cellulose foam may be decreased, since the pores on the outer surface are covered by the substrate. By decreasing the air permeability of the cellulose foam by attaching a substrate on at least one outer surface, use of the resulting packaging material in automated processes involving vacuum is greatly facilitated. The packaging material may for example be used in converting and packaging processes involving steps requiring vacuum lifting and fixation. The lower air permeability also improves the performance of the packaging material in thermal packaging.

Attaching a substrate to the cellulose foam may also improve other properties such as stability, rigidity and strength, of the packaging material. For example, the load-bearing properties are improved when a rigid substrate is attached to the cellulose foam since pressure may be distributed over a wider area to minimize compression under pressure, which enables use of die-cutting. By attaching a substrate to the cellulose foam, rigidity of the substrate can be combined with the cushioning properties of the foam to enable a packaging material with properties that can be tailormade for different applications, including also heavier products. When using thin pieces of cellulose foam, handling is greatly facilitated by attaching a substrate to the foam. The risk of tearing the thin pieces of foam is also reduced.

The substrate preferably has a flat shape, such as being in the form of a sheet, film or foil. The substrate comprises at least a first surface and a second surface. The substrate comprises a first surface which is at least partly attached to the cellulose foam.

The term “attached” as used herein, refers to a process of permanently attaching two objects, in this case the cellulose foam and the substrate.

In some embodiments, the area of the first surface of the substrate has the same size as the area of the outer surface of the cellulose foam that the substrate is attached to. Thus, in such embodiments, the entire first surface of the substrate is attached to the cellulose foam.

In some embodiments, the area of the first surface of the substrate that is attached to the cellulose foam has a larger, or smaller, size than the area of the outer surface of the cellulose foam that the substrate is adhered to. Thus, in such embodiments, the first surface of the substrate is partly attached to the cellulose foam.

In some embodiments, the substrate is attached to one outer surface of the cellulose foam. For example, a board may be attached to a cellulose foam plank, the area of the first surface of the board being of roughly the same size as the outer surface of the plank.

In some embodiments, the substrate is attached to at least two outer surfaces of the cellulose foam. In such embodiments, the substrate may be folded along at least one folding line such that it may be attached to at least two outer surfaces of the cellulose foam. For example, a paperboard may be provided with folding lines corresponding to the edges of a cellulose foam plank. By folding the paperboard along the folding lines, the cellulose foam may on all sides be attached to the paperboard.

In some embodiments, the substrate may be a plastic film or a metal foil. The plastic film may for example be selected from polyethylene, cellophane or polylactic acid. The metal foil may for example be an aluminium foil. The plastic film and the metal foil must be thin enough so that the packaging material can be recycled in regular paper recycling streams. The air permeability of the cellulose foam is reduced when attaching a plastic film or metal foil to an outer surface of the cellulose foam.

In some embodiments where the substrate is a plastic film or a metal foil, the plastic film and the metal foil are preferably, but not necessarily, thin enough so that the packaging material can be recycled in regular paper recycling streams.

In a preferred embodiment, the substrate is a fibrous substrate. The fibrous substrate preferably comprises cellulose fibres. The cellulose fibres may be selected from wood pulp; regenerated cellulose fibres; and plant fibres, such as fibres from bamboo, cotton, hemp, flax, and jute. Preferably, the cellulose fibres are selected from wood pulp, such as softwood pulp, hardwood pulp, chemical-thermomechanical pulp, and from dissolving pulp, or a combination of one or more of these.

The fibrous substrate may preferably be selected from paper or board. For example, the fibrous substrate may be a paperboard, cardboard or corrugated board.

The term “paper” as used herein generally refers to a material manufactured in sheets or rolls from the pulp of wood or other fibrous substances comprising cellulose fibers, used for e.g. writing, drawing, or printing on, or as packaging material. Paper can either be bleached or unbleached, coated or uncoated, and produced in a variety of thicknesses, depending on the end-use requirements.

The term “board” as used herein generally refers to strong, thick paperboard or cardboard comprising cellulose fibers used for example as flat substrates, trays, boxes and/or other types of packaging. Board can either be bleached or unbleached, coated or uncoated, and produced in a variety of thicknesses, depending on the end-use requirements.

Advantages with using paper or board as the substrate is that the packaging material comprising cellulose foam attached to paper or board may be re-dispersed in water and as a result will easily be recyclable in regular paper recycling streams. The air permeability is also decreased by attaching a paper or board substrate to the cellulose foam, and the stability of the foam may be increased.

The basis weight of the fibrous substrate is preferably at least 20 g/m², or at least 80 g/m². The basis weight of the fibrous substrate is preferably less than 500 g/m², or less than 400 g/m². The basis weight of the fibrous substate may be in the range of from 20 to 500 g/m², or from 80 to 500 g/m², or from 120 to 500 g/m².

The substrate may be selected so as to infer desired properties apart from a decrease in air permeability and increased strength and stability to the packaging material. For example, if the packaging material is to be printed in the converting process, it is advantageous to attach a substrate that will improve the printability by minimizing ink bleeding. The substrate may also be selected so as to alter the look and feel of the packaging material, with regards to properties such as gloss and texture. In applications where it is important that the packaging material has improved water resistance, a substrate with hydrophobic properties may be selected.

In some embodiments, the substrate is a second cellulose foam material. Such embodiments provide a layered cellulose foam material. The second cellulose foam may have a composition that is identical to or different from the composition of the cellulose foam. The second cellulose foam may further be selected so as to provide certain desired properties to the packaging material, as further discussed above.

In some embodiments, the substrate is a different foam material, such as a starch foam.

In some embodiments, a second substrate is attached to at least one outer surface of the cellulose foam. The second substrate may be identical to or different from the substrate. The substrate and the second substrate may be attached to the same outer surface of the cellulose foam, or to different outer surfaces. In one preferred embodiment, the substrate and second substrate are attached to opposite outer surfaces of the cellulose foam, such that the cellulose foam is sandwiched between the substrate and the second substrate. For example, cardboard may be put on the top and bottom side of a cellulose foam.

By attaching a second substrate to the cellulose foam, the strength and rigidity is further improved. By selecting a second substrate different from the substrate, a packaging material with different properties on different sides may be provided. For example, the aesthetics may be improved on the top side of a cellulose foam, while the foam is provided with an improved strength on the back side.

The second substrate may be further defined as outlined above with reference to the substrate.

In some embodiments, the cellulose foam comprises at least two individual pieces of cellulose foam, and wherein the substrate is attached to at least one outer surface of all of said at least two individual pieces. The composition of the cellulose foam in the at least two individual pieces may be identical or different. Other properties, such as density, size and shape of the at least two individual pieces may be identical or different. By providing at least two individual pieces of cellulose foam and attaching a substrate to at least one outer surface on each of the at least two individual pieces of cellulose foam, a highly versatile packaging material is provided. By selecting pieces of cellulose foam having defined shapes and properties and attaching those to a substrate, a packaging material with tailormade rigidity and cushioning properties depending on the application may be provided.

In some embodiments, the packaging material comprises an adhesive layer between the at least one outer surface of the cellulose foam and the substrate. The substrate is attached to the at least one outer surface of the cellulose foam by means of the adhesive layer. The adhesive layer may comprise any suitable adhesive, such as a hot melt glue, a wood adhesive, a starch-based glue, carboxymethyl cellulose (CMC), polyvinyl acetate, ethylene vinyl acetates, casein, latex, polyurethane, dextrin and gums, such as guar and xanthan. The adhesive is preferably water-based and/or biobased.

In some embodiments, the adhesive layer is a double-sided adhesive tape.

In embodiments where the cellulose foam comprises CMC, the adhesive layer may comprise water. The water will partly dissolve the outer surface of the cellulose foam and provide adhesive properties by exposing CMC. The substrate may be attached to the partly dissolved outer surface.

In some embodiments, the adhesive layer may comprise a thin layer of wet cellulose foam. Using a thin layer of wet foam as the adhesive layer is particularly suitable when the substrate is a second cellulose foam, thus creating a layered material only comprising cellulose foam.

In some embodiments, the packaging material comprises at least two adhesive layers. The composition of the adhesive layers may be identical or different.

In embodiments where a second substrate is attached to the cellulose foam, the second substrate may be attached by means of an adhesive layer as defined above.

The packaging material may also comprise additional layers. The type of material in the additional layers is not particularly limited. It may for example be a cellulose foam, it may be a paper or board, a plastic film or a metal foil. For example, additional layers may be attached to other sides of the substrate. In one example, a corrugated board substrate is attached to a cellulose foam, and another cellulose foam is attached to the opposite side of the corrugated board, so that the corrugated board is sandwiched between two layers of cellulose foam. In another example, a plastic film is attached to a paperboard substrate which is in turn attached to a cellulose foam.

According to a second aspect, the present invention relates to a method for producing a packaging material comprising a cellulose foam having a density in the range of from 10 to 80 kg/m³, such as from 10 to 60 kg/m³, or from 20 to 50 kg/m³. Step a) of the method according to the second aspect involves providing a cellulose foam. The provided cellulose foam may be wet or dry. If a wet cellulose foam is provided, it may be applied on top of the substrate and then dried. Alternatively, a substrate may be attached on top of a wet foam, prior to letting the wet foam dry. The density of the wet foam may be in the range of from 140 to 500 kg/m³. Due to the viscoelastic properties of the wet foam of the present invention, it will be free-standing and thus have outer sides that a substrate can be attached to.

In embodiments where the cellulose foam is provided as a solid cellulose foam, the foam may have a solid content in the range of from 95 to 100 wt %, preferably from 98 to 100 wt %, as calculated on the total weight of the cellulose foam. The cellulose foam has at least one outer surface.

The cellulose foam may be further defined as set out above with reference to the first aspect.

Step b) of the method according to the second aspect involves providing a substrate. The substrate is preferably dry. The substrate comprises a first surface and at least one second surface. Preferably, the substrate is in the form of a sheet, film or foil. The substrate may be further defined as set out above with reference to the first aspect.

Step c) of the method according to the second aspect involves attaching the first surface of the substrate to at least one outer surface of the cellulose foam. The step of attaching may involve applying an adhesive layer on the first surface of the substrate and/or on the at least one surface of the cellulose foam.

The step of attaching the first surface of the substrate to at least one outer surface of the cellulose foam involves putting the first surface of the substrate and the at least one outer surface of the cellulose foam in close contact with each other. In some embodiments, an adhesive layer is situated in between the outer surface of the cellulose foam and the first surface of the substrate.

In some embodiments, pressure is applied when the first surface of the substrate is attached to the at least one outer surface of the cellulose foam. By applying a pressure during the attachment step, it is ensured that the substrate and the cellulose foam come into close contact with each other so as to ensure a strong attachment. Pressure may be applied using any suitable pressing means. For example, pressing means such as rollers, bars or plates may be used. Pressure may be applied to the substrate, or to the cellulose foam or to both. For example, after the substrate has been placed on the cellulose foam, the structure may be passed underneath a roller applying pressure so that the substrate is firmly attached to the cellulose foam.

The attachment step typically involves manually or automatically placing the cellulose foam on the substrate or vice versa. Any suitable equipment as known by a person skilled in the art can be used. For example, an adhesive layer is first applied to an outer surface of the cellulose foam (typically the top surface), after which cardboard is placed on the outer surface. The cardboard may be supplied from a roller, which may also apply pressure when placing the cardboard on the cellulose foam so as to ensure a strong attachment. Alternatively, pressure may be applied by a second roller.

Depending on the substrate and on the attachment means, an elevated temperature may be used during the attachment step. For example, in embodiments where the substrate is a plastic film, the plastic film and/or the cellulose foam may be heated during the attachment step such that the plastic film is laminated to the cellulose foam. Certain adhesives may also require heating. In embodiments where pressure is applied during the attachment step, heat may be supplied by the pressing means, such as by using a heated roller.

The adhesive layer may be applied on the first surface of the substrate and/or on the outer surface of the cellulose foam using any suitable method used for coating such as roller coating, blade/knife coating, brushing, flexo roller and spray coating. In some embodiments, the adhesive layer is applied on the first substrate of the substrate prior to attaching the substrate to the cellulose foam. In some embodiments, the adhesive layer is applied on the outer surface of the cellulose foam prior to attaching the substrate to the cellulose foam. In some embodiments, an adhesive layer is applied both on the first surface of the substrate and on the at least one outer surface of the cellulose foam prior to attaching the substrate to the cellulose foam. By applying an adhesive layer to both the substrate and to the cellulose foam, the attachment may be stronger and more durable.

In some embodiments the method involves the additional steps of providing a second substrate and attaching said substrate to at least one outer surface of the cellulose foam. A first surface of the substrate is attached to at least one outer surface of the cellulose foam. The second substrate is preferably attached by applying an adhesive layer on the first surface of the second substrate and/or on the at least one outer surface of the cellulose foam. The second substrate may be further defined as set out above with reference to the first aspect.

In embodiments involving a second substrate, the second substrate may be attached to the cellulose foam simultaneously with the substrate, or after the substrate has been attached to the cellulose foam. Attachment of the second substrate may involve an adhesive layer, pressure and/or an elevated temperature, as further outlined above in relation to the step of attaching the substrate.

The adhesive layer may comprise more than one sub-layer of adhesive, such as at least two sub-layers of adhesive, or at least three sub-layers of adhesive. The adhesive composition in the at least two sub-layers may be identical or different. The adhesive and the adhesive layer may be further defined as set out above with reference to the first aspect.

Step d) of the method according to the second aspect involves an optional step of drying the packaging material. The packaging material may be dried by evaporation at room temperature or at an elevated temperature, such as a temperature of from 40 to 140° C. Any suitable drying equipment, such as an oven or infrared heating, may be used.

In embodiments where the provided cellulose foam is a wet cellulose foam, drying is required for obtaining the packaging material. Drying may also be beneficial in embodiments involving an adhesive layer.

### EXAMPLES

### Example 1—Preparation of Cellulose Foam

A uniform wet paste comprising cellulose pulp fibres (softwood Kraft bleached pulp), thickener (CMC) and water was prepared. The solid concentration of the wet paste was 13.2 wt %. The paste was aerated after addition of surfactant (mix of myristic acid and sodium cocoyl sarcosinate) by means of mechanical mixing until a wet foam having a density of 226 kg/m³ was obtained. The composition of the wet foam is shown in table 1. The wet foam was then used to fill a wooden frame. Once the frame was completely filled with wet foam, the extra foam was scraped off to obtain a smooth surface. The foam was dried in an oven at 120° C. until it was completely dry. The dry cellulose foam had a density of 30 kg/m³. The foam had a flat shape with a thickness of 5 cm.

TABLE 1

| Component | Amount (%) |
|---|---|
| Cellulose pulp fibers | 11.33 |
| Thickener | 1.26 |
| Surfactant | 0.24 |
| Total | 12.83 |

### Example 2—Preparation of a Packaging Material

The cellulose foam plank of example 1 was used to prepare a packaging material. An adhesive layer comprising CMC solution (10 wt % in water) was coated on the top and bottom surfaces of the foam plank. The adhesive layer was applied in an amount of 20 g/m² dry material. A single layer of recycled corrugated paperboard was attached to the top and bottom surfaces of the foam plank, resulting in a packaging material where the cellulose foam plank is sandwiched between two layers of corrugated paperboard. The size of the corrugated paperboard was the same as the size of the foam plank. Attaching corrugated paperboard to the foam improved the mechanical properties of the foam. The corrugated board had a thickness of 2.5 mm and the basis weight of the corrugated board was 70 g/m² with basis weight of kraft liner of 50 g/m².

In view of the above detailed description of the present invention, other modifications and variations will become apparent to those skilled in the art. However, it should be apparent that such other modifications and variations may be effected without departing from the spirit and scope of the invention.

1. A packaging material comprising:
a cellulose foam having a density in a range of from 10 to 80 kg/m³, and
a substrate, wherein the substrate is attached to at least one outer surface of the cellulose foam.

2. The packaging material according to claim 1, wherein the cellulose foam comprises cellulose fibres in a range of from 71 to 95 wt % based on a total dry weight of the cellulose foam.

3. The packaging material according to claim 1, wherein the cellulose foam comprises:
cellulose fibres in a range of from 71 to 95 wt % based on a total dry weight of the cellulose foam,
a water-soluble thickener in a range of from 4 to 24 wt % based on the total dry weight of the cellulose foam, and
at least two surfactants.

4. The packaging material according to claim 1, wherein the substrate is a fibrous substrate.

5. The packaging material according to claim 1, wherein the substrate is selected from a group consisting of: paper and board.

6. The packaging material according to claim 1, wherein the substrate is a second cellulose foam, and
wherein the second cellulose foam has a composition that is different from a composition of said cellulose foam.

7. The packaging material according to claim 1, wherein the cellulose foam comprises at least two individual pieces of cellulose foam, and
wherein the substrate is attached to at least one outer surface of all of said at least two individual pieces.

8. The packaging material according to claim 1, wherein the packaging material comprises an adhesive layer between the at least one outer surface of the cellulose foam and the substrate.

9. The packaging material according to claim 1, wherein a second substrate is attached to at least one outer surface of the cellulose foam.

10. A method for producing a packaging material comprising a cellulose foam having a density in a range of from 10 to 80 kg/m³, the method comprising the following steps:
a) providing a cellulose foam;
b) providing a substrate having a first surface; and,
c) attaching the first surface of the substrate to at least one outer surface of the cellulose foam so as to obtain a packaging material; and,
d) optionally, drying the packaging material.

11. The method according to claim 10, wherein the cellulose foam is provided as a wet foam having a density in a range of from 140 to 500 kg/m³.

12. The method according to any one of claim 10, wherein the cellulose foam is provided as a solid cellulose foam, having a density in a range of from 10 to 80 kg/m³.

13. The method according to claim 10, wherein the cellulose foam comprises cellulose fibres in a range of from 71 to 95 wt % based on a total dry weight of the cellulose foam.

14. The method according to claim 10, wherein the cellulose foam comprises:
cellulose fibres in a range of from 71 to 95 wt % based on a total dry weight of the cellulose foam,
a water-soluble thickener in a range of from 4 to 24 wt % based on the total dry weight of the cellulose foam, and
at least two surfactants.

15. The method according to claim 10, wherein the substrate is a fibrous substrate.

16. The method according to claim 10, wherein the substrate is selected from a group consisting of: paper and board.

17. The method according to claim 10, wherein the substrate is a second cellulose foam, and
wherein the second cellulose foam has a composition that is different from a composition of said cellulose foam.

18. The method according to claim 10, wherein the cellulose foam is provided as at least two individual pieces of cellulose foam, and
wherein the substrate is attached to at least one outer surface of all of said at least two individual pieces.

19. The method according to claim 10, wherein the step of attaching the substrate to the at least one surface of the cellulose foam includes applying an adhesive layer on the first surface of the substrate, or on the at least one surface of the cellulose foam, or on both.

20. The method according to claim 10, further comprising the steps of:
providing a second substrate; and
attaching said second substrate to at least one outer surface of the cellulose foam.
